(19) United States
(12) Patent Application Publication
(10) Pub. No.: US 2025/0208721 A1
(43) Pub. Date: Jun. 26, 2025

(54) DISPLAY CONTROL DEVICE, DISPLAY CONTROL METHOD, AND DISPLAY CONTROL PROGRAM

(71) Applicant: SONY GROUP CORPORATION, TOKYO (JP)

(72) Inventors: RURI OYA, TOKYO (JP); KAZUKI YOKOYAMA, TOKYO (JP)

(21) Appl. No.: 18/850,681

(22) PCT Filed: Mar. 10, 2023
(86) PCT No.: PCT/JP2023/009231

§ 371 Date: Sep. 25, 2024

(30) Foreign Application Priority Data
Apr. 4, 2022 (JP) 2022-062378

(51) Int. Cl. G06F 3/0346; G06F 3/01; G06T 15/20; H04N 13/302; H04N 13/398

(52) U.S. Cl. CPC G06F 3/0346; G06F 3/013; G06T 15/20; H04N 13/302; H04N 13/398

(57) ABSTRACT

A display control device (100) according to an aspect of the present disclosure includes an acquisition unit (131) that acquires position and posture information about an input apparatus located in a real space, an extraction unit (133) that extracts, from virtual content stereoscopically displayed in the real space by a stereoscopic display, part of the virtual content in a virtual space based on the position and posture information about the input apparatus, and a generation unit (134) that generates video content based on information extracted by the extraction unit.

### FIELD

The present disclosure relates to a display control device, a display control method, and a display control program for displaying content in a virtual space.

### BACKGROUND

With development of video display technology, it is possible to superimpose content in a virtual space on a real space or stereoscopically view a virtual object like a real object.

In this regard, there is known a technique of expanding a table or a wall face in a real space as a display of a computer, and displaying a virtual object, which is a virtual entity, in the real space in cooperation with a plurality of displays in the real space (for example, Patent Literature 1). In addition, there is known a technique of rendering and stereoscopically displaying a virtual object according to a viewpoint of a user to make the user perceive the virtual object as if the virtual object were a real object (for example, Patent Literature 2). A display that realizes such a display mode is referred to as an eye-sensing light field display or a spatial reproduction display.

### CITATION LIST

### Patent Literature

Patent Literature 1: JP 2001-136504 A
Patent Literature 2: WO 2018/504678 A

### SUMMARY

### Technical Problem

According to the prior art, since a virtual object can be displayed with a texture like a real object, for example, the virtual object can effectively function in 3D content creation.

On the other hand, when the virtual object displayed stereoscopically is captured or recorded by the camera in the real space, it is difficult to reproduce the appearance and texture of the virtual object due to the principle of display. There is also a method of setting a virtual camera in a virtual space and performing imaging, but there are problems that it is troublesome to set an imaging trajectory, and it is difficult to intuitively perform setting since imaging cannot be performed while actually viewing an object.

Therefore, the present disclosure proposes a display control device, a display control method, and a display control program capable of simply and intuitively controlling display of virtual content.

### Solution to Problem

A display control device according to an embodiment of the present disclosure includes an acquisition unit that acquires position and posture information about an input apparatus located in a real space, an extraction unit that extracts, from virtual content stereoscopically displayed in the real space by a stereoscopic display, part of the virtual content in a virtual space based on the position and posture information about the input apparatus, and a generation unit that generates video content based on information extracted by the extraction unit.

### BRIEF DESCRIPTION OF DRAWINGS

FIG. 1 is a diagram illustrating an outline of a process of a display control process according to the embodiment.

FIG. 2 is a diagram (1) illustrating an example of a procedure of a display control process according to the embodiment.

FIG. 3 is a diagram (2) illustrating an example of a procedure of a display control process according to the embodiment.

FIG. 4 is a diagram schematically illustrating a flow of a display control process according to the embodiment.

FIG. 5 is a diagram illustrating a configuration example of a display control device according to the embodiment.

FIG. 6 is a flowchart illustrating a flow of processing according to the embodiment.

FIG. 7 is a diagram illustrating an example of a display control process according to the modification.

FIG. 8 is a hardware configuration diagram illustrating an example of a computer that implements functions of a display control device.

### DESCRIPTION OF EMBODIMENTS

Hereinafter, the embodiments will be described in detail with reference to the drawings. In the following embodiments, the same parts are denoted by the same reference signs, and a duplicate description will be omitted.

The present disclosure will be described in the order of the following items.
1. Embodiment
1-1. Outline of display control process according to embodiment
1-2. Configuration of display control device according to embodiment
1-3. Procedure of processing according to embodiment
1-4. Modifications
1-4-1. Detection process of imaging target
1-4-2. Modifications regarding imaging direction
1-4-3. Display control process with a plurality of input apparatuses
2. Other embodiments
3. Effects of display control device according to present disclosure
4. Hardware configuration

### 1. Embodiment

### (1-1. Outline of Display Control Process According to Embodiment)

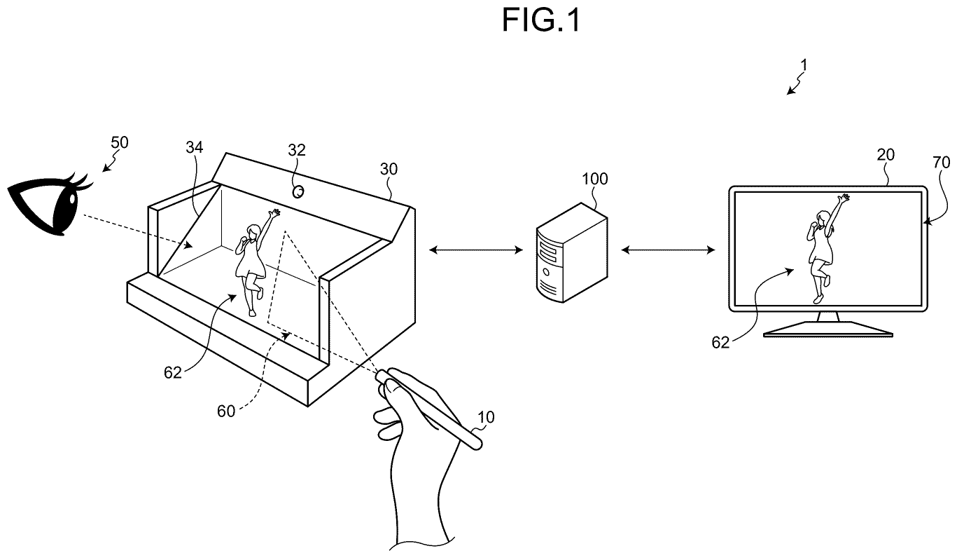

An example of a display control process according to the embodiment will be described with reference to FIG. 1. FIG. 1 is a diagram illustrating an outline of a display control process according to the embodiment. FIG. 1 illustrates components of a display control system 1 that executes a display control process according to the embodiment.

As illustrated in FIG. 1, the display control system 1 includes a display control device 100, a pointing device 10, a visual display 20, and a stereoscopic display 30.

The display control device 100 is an example of an information processing device that executes a display control process according to the embodiment. For example, the display control device 100 is a server device, a personal computer (PC), or the like. The display control device 100 acquires position and posture information about the pointing device 10, controls a stereoscopic display process on the stereoscopic display 30, and controls a display process and the like of video content on the visual display 20 via the network.

The pointing device 10 is an example of an input apparatus according to the embodiment. In the embodiment, the pointing device 10 is operated by a user 50 and used to input various types of information to the display control device 100. For example, the pointing device 10 includes a sensor such as an inertial sensor, an acceleration sensor, and a gravity sensor, and can detect position and posture information about the pointing device itself. The pointing device 10 transmits the detected position and posture information about the own device to the display control device 100. Further, the pen-shaped pointing device 10 illustrated in FIG. 1 causes the display control device 100 to recognize the coordinate position of the pen tip in the real space, so that an input position and coordinates on the screen can be designated. The display control device 100 executes various processes based on the acquired position and posture information and designated position information. For example, the display control device 100 can move a pointer on the screen or change screen display based on the position and posture information about the pointing device 10.

Although the pointing device 10 which is a pen-type pointing stick is illustrated as the input apparatus in FIG. 1, the input apparatus is not limited to the pen-type device, and any device may be used as long as the device can acquire the position information in the real space. For example, the pointing device 10 may be a controller linked with a virtual reality (VR) device or an augmented reality (AR) device, an air mouse, a digital camera, a smartphone, or the like. Furthermore, in a case where the stereoscopic display 30 or the display control device 100 can capture the position and posture information about the input apparatus, the input apparatus may not include the sensor. For example, the input apparatus may be a predetermined object, a human face, a finger, or the like provided with a marker that can be recognized by the stereoscopic display 30, the display control device 100, or a predetermined external apparatus (a video camera or the like installed in a real space).

The visual display 20 is a display for displaying video content or the like generated by the display control device 100. For example, the visual display 20 includes a screen including a liquid crystal panel, an organic light emitting diode (OLED) panel, or the like.

The stereoscopic display 30 is a display capable of stereoscopically displaying virtual content in a real space. The stereoscopic display 30 is a so-called naked-eye stereoscopic display capable of stereoscopic viewing without the user 50 wearing dedicated glasses or the like. In the embodiment, the stereoscopic display 30 includes a sensor unit 32 and an inclined screen 34 inclined by a predetermined angle with respect to the horizontal plane.

The sensor unit 32 is a sensor that detects the outside world. For example, the sensor unit 32 includes a plurality of sensors such as a visible light camera, a distance measurement sensor, and a line-of-sight detection sensor. The visible light camera captures a visible light image of the outside world. The distance measurement sensor detects a distance of a real object existing in the outside world using a flight time of laser light or the like. The line-of-sight detection sensor detects the line-of-sight of the user 50 directed to the inclined screen 34 using a known eye tracking technology.

The inclined screen 34 presents video information to the user 50. For example, the inclined screen 34 presents the virtual content stereoscopically displayed in the real space to the user 50 by a known stereoscopic display technology. Specifically, the inclined screen 34 displays the virtual content perceived by the user 50 as one stereoscopic image by fusing the viewpoint images appearing in the left and right eyes of the user 50. In the example of FIG. 1, the stereoscopic display 30 displays a virtual object 62, which is an example of virtual content and an example of a character imitating a human, on the inclined screen 34. That is, the stereoscopic display 30 displays the virtual object 62 at an angle of view (hereinafter, such an angle of view based on the line-of-sight of the user 50 may be referred to as a “first angle of view”.) based on the line-of-sight of the user 50. Note that, in the embodiment, the display control process in the stereoscopic display 30 is controlled by the display control device 100.

As described above, according to the stereoscopic display 30, the user 50 can stereoscopically view the virtual object 62. The stereoscopic display 30 detects the line-of-sight of the user 50 and stereoscopically displays a video based on the detected line-of-sight. Therefore, the user 50 can perceive the virtual object 62 as a realistic display as if the virtual object 62 exists on the spot.

Here, there is a case where the user 50 desires to capture the virtual object 62 or record the virtual object 62 to make a video. For example, in a case where the virtual object 62 is a product or the like before being actually formed, the user 50 first produces the virtual object 62 as virtual content (for example, a 3D model or the like by computer graphics.). Then, while displaying the virtual object 62 on the stereoscopic display 30, the user 50 confirms the texture of the virtual object 62, the appearance from various angles, and the motion set to the virtual object 62. At this time, the user 50 desires to image the appearance of the virtual object 62 from various angles while visually recognizing the virtual object 62.

However, even when the virtual object 62 displayed stereoscopically is captured or recorded by a camera in the real space, it is difficult to reproduce the appearance and texture of the virtual object 62 due to the principle of stereoscopic display. At this time, the user 50 may employ a method of setting a virtual camera in the virtual space and capturing the virtual object 62. However, in order to actually set the trajectory of the virtual camera, the user 50 is required to set the three-dimensional range in the virtual space using, for example, a two-dimensional device such as a mouse or a two-dimensional display, and cannot easily set the trajectory. There are imaging assist tools capable of displaying three-dimensional information such as a head mounted display, but it is necessary to perform setting from a first-person viewpoint due to the characteristics of the device, and thus, it is difficult to perform intuitive setting.

Therefore, the display control device 100 according to the embodiment solves the above problem by the following processing. Specifically, the display control device 100 acquires the position and posture information about the pointing device 10 located in the real space. Then, the display control device 100 extracts part of the virtual object 62 in the virtual space from the virtual object 62 stereoscopically displayed in the real space by the stereoscopic display 30 based on the position and posture information about the pointing device 10. Then, the display control device 100 generates the video content based on the extracted information.

That is, the display control device 100 can extract part of the virtual space as if capturing in the real space by using the stereoscopic display 30 that enables viewing the virtual space from the real space at the third person's viewpoint and the pointing device 10 that can be moved around the virtual object 62 in the real space. More specifically, the display control device 100 regards an instruction destination (a pen tip in the example of FIG. 1) of the pointing device 10 as a viewpoint, and gives a predetermined angle of view to extract part of the virtual space so that pointing device 10 captures the virtual object 62. Note that the predetermined angle of view refers to an angle of view of the virtual camera set in advance in the pointing device 10 or determined by a focal length or the like with respect to a virtual object to be imaged, and may be referred to as a “second angle of view” for distinction in the following. The second angle of view corresponds to an angle of view 60 in the example of FIG. 1.

Then, the display control device 100 generates the video content from the extracted information, and displays the generated video content on visual display 20, for example. As a result, the user 50 can visualize the virtual object 62 from an angle desired by the user 50, while visually recognizing the virtual object 62. For example, in a case where the virtual object 62 is a 3D model or the like of a prototype before manufacturing, the user 50 can generate video content for sales promotion by using the display control process according to the embodiment before actually manufacturing the virtual object 62 in the real space. Alternatively, the user 50 can share a video obtained by imaging the virtual object 62 from various angles with another user, for example, in a presentation place.

The above display control process will be described with reference to FIG. 1. In the example illustrated in FIG. 1, the display control device 100 controls the stereoscopic display 30 so as to stereoscopically display the virtual object 62 based on the line-of-sight information about the user 50 acquired by the sensor unit 32.

The user 50 holds the pointing device 10 in the hand and points the pen point at the virtual object 62 displayed stereoscopically on the stereoscopic display 30. At this time, the display control device 100 acquires the position and posture information about the pointing device 10.

The display control device 100 matches the coordinate system of the stereoscopic display 30 with the coordinate system of the pointing device 10 in the real space based on the acquired position and posture information. That is, the display control device 100 converts the coordinate system so that the position of the pointing device 10 in the real space is superimposed on a pointer (that is, the position of the virtual camera) moving in the virtual space. For example, the display control device 100 calculates a conversion matrix for matching the coordinate system of the stereoscopic display 30 with the coordinate system of the pointing device 10 in the real space by comparing the known coordinates in the calibration in advance. Then, the display control device 100 transforms the coordinate system in the real space into the coordinate system in the virtual space using the calculated conversion matrix, and causes the coordinate systems to coincide with each other.

Subsequently, the display control device 100 extracts the virtual space displayed by the stereoscopic display 30 based on the position and posture information about the pointing device 10. In this case, the position and posture information includes information related to the direction which the pointing device 10 points. For example, the display control device 100 extracts the virtual space in a mode of a two-dimensional image that can be displayed on a two-dimensional display. Then, the display control device 100 can generate one piece of video content as if the virtual object 62 is imaged by the pointing device 10 by rendering the extracted image along the time axis.

The display control device 100 causes the visual display 20 to display the generated video content. As illustrated in FIG. 1, a video 70 displayed on visual display 20 is a video in which virtual object 62 on the stereoscopic display 30 is imaged at the predetermined angle of view 60 corresponding to the direction which the pointing device 10 points.

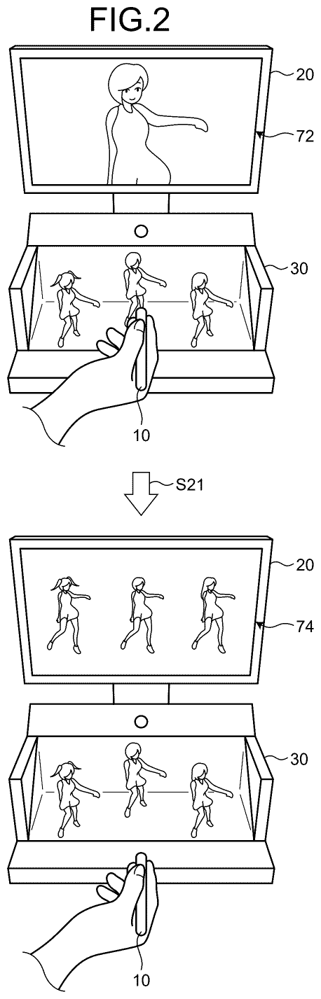

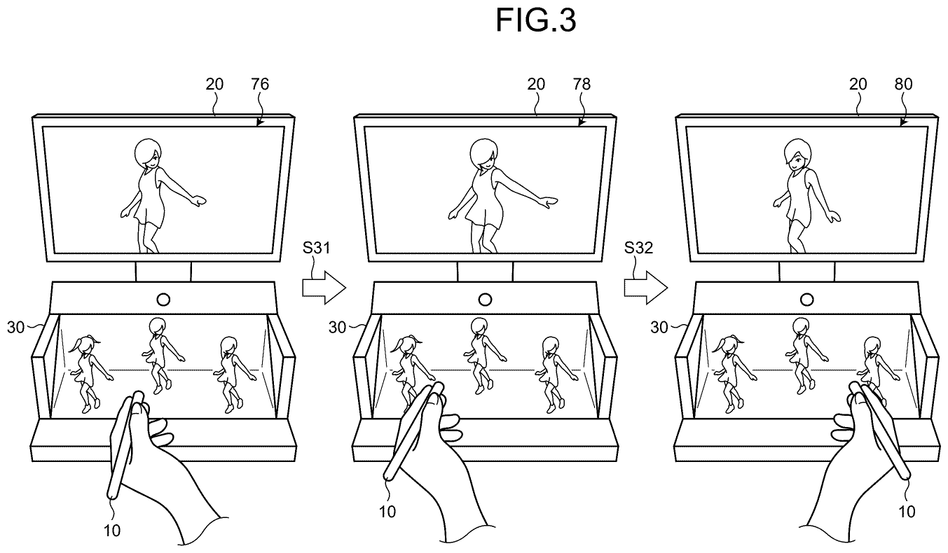

Note that display control device 100 can generate video content of various modes by using the position and posture information about pointing device 10. This point will be described with reference to FIGS. 2 and 3.

First, an example of a video generated when the pointing device 10 approaches or moves away from the virtual content displayed on the stereoscopic display 30 will be described with reference to FIG. 2. FIG. 2 is a diagram (1) illustrating an example of a procedure of the display control process according to the embodiment.

In the example illustrated in FIG. 2, it is assumed that the stereoscopic display 30 displays a virtual object including three characters. When the user 50 brings the pointing device 10 closer to the virtual object, the display control device 100 can generate a video 72 in which one virtual object is displayed large on the screen. This means that the display control device 100 has corrected the angle of view (viewing angle) of the virtual camera to be narrow by shortening the focal length to the virtual object based on the position and posture information about the pointing device 10.

Next, the user 50 moves the pointing device 10 away from the virtual object (Step S21). Then, the display control device 100 can generate a video 74 in which all the three virtual objects are displayed within the angle of view. This means that the display control device 100 has corrected the angle of view of the virtual camera to be wide by increasing the focal length to the virtual object based on the position and posture information about the pointing device 10. As described above, the display control device 100 regards the pointing device 10 as a camera, and sets the camera parameters based on the position and posture information, so that it is possible to generate a video as if the virtual object is imaged by the camera in the real space.

Next, another display example will be described with reference to FIG. 3. FIG. 3 is a diagram (2) illustrating an example of a procedure of the display control process according to the embodiment. The example of FIG. 3 illustrates a situation in which the user 50 moves the pointing device 10 in the horizontal direction with respect to the same virtual object as in FIG. 2.

The example illustrated in the left part of FIG. 3 illustrates a state in which the user 50 directs the pointing device 10 in front of the virtual object. At this time, the display control device 100 generates a video 76 displayed as if the virtual object is viewed from the front.

Next, the user 50 moves the pointing device 10 to the left from the position facing the virtual object (Step S31). Based on the position and posture information about the pointing device 10, the display control device 100 generates a video 78 as if the virtual object is imaged from the camera on the left side.

Next, the user 50 moves the pointing device 10 to the right from the position facing the virtual object (Step S32). Based on the position and posture information about the pointing device 10, the display control device 100 generates a video 80 as if the virtual object is imaged from the camera on the right side.

As described above, the display control device 100 regards the pointing device 10 as a camera, and can generate a video imitating panning of camera imaging based on the position and posture information.

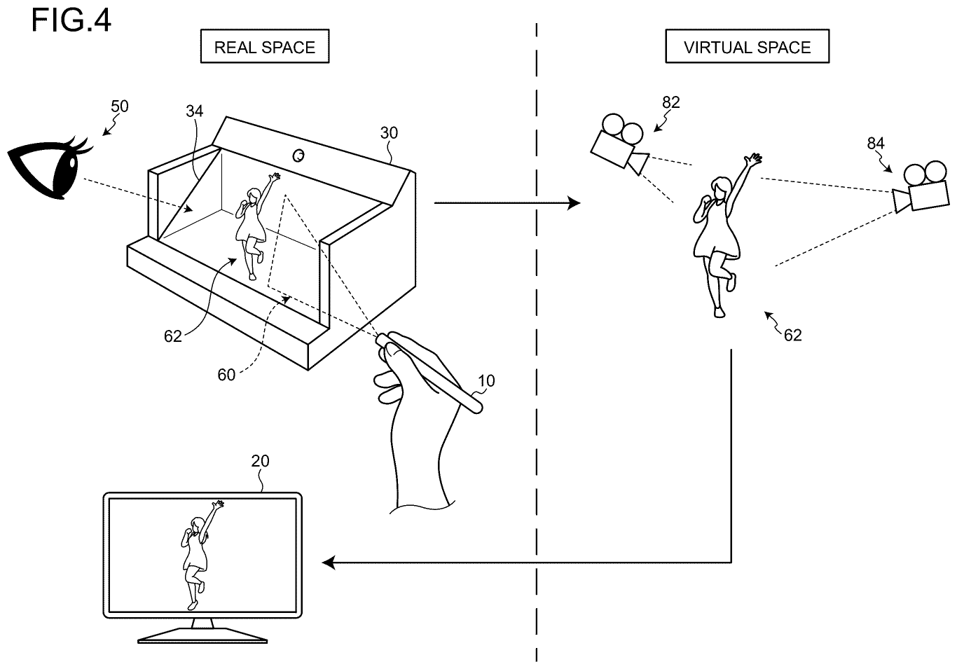

Next, information about the real space and information about the virtual space processed by the display control device 100 will be described with reference to FIG. 4. FIG. 4 is a diagram schematically illustrating a flow of a display control process according to the embodiment.

As illustrated in FIG. 4, the user 50 operates the pointing device 10 while viewing the stereoscopic display 30 in the real space. At this time, the display control device 100 acquires the line-of-sight information about the user via the sensor unit 32 of the stereoscopic display 30. In addition, the display control device 100 acquires the position and posture information about the pointing device 10 via a sensor included in the pointing device 10. Furthermore, the display control device 100 acquires the relative positional relationship between the stereoscopic display 30 and the pointing device 10 via the sensor unit 32 of the stereoscopic display 30 and the sensor included in the pointing device 10.

Note that, in a case where there is pre-setting by the user, the display control device 100 may acquire various parameters related to imaging. For example, the display control device 100 acquires information such as the angle of view 60 set in the pointing device 10, setting of a focal length, designation of a target point (for example, the virtual object 62), and a depth of field. The target point is, for example, information designating a target of what the camera automatically follows as the center of the angle of view. Note that, in a case where there is no setting value by the user, the display control device 100 may apply a fixed camera parameter that is initially set, or a camera parameter such as an angle of view that is automatically corrected in accordance with the distance between the pointing device 10 and the virtual object 62.

The display control device 100 extracts information that is a source of the video content in the virtual space based on the acquired information.

For example, the display control device 100 superimposes the position and posture information about the user's eyes on the coordinates and orientation of a virtual camera 82 in the virtual space based on the user's line-of-sight information. The position of the virtual camera 82 is used when the stereoscopic display 30 stereoscopically displays the virtual object 62.

Furthermore, the display control device 100 superimposes the position and posture information about the pointing device 10 on the coordinates and orientation of a virtual camera 84 in the virtual space. In addition, the display control device 100 identifies a range imaged by the virtual camera 84 based on the camera parameters set in the virtual camera 84, and extracts the identified range. In other words, the display control device 100 identifies the range (coordinates) of the virtual space cut by the angle of view of the virtual camera 84 and extracts the space. Note that the extracted virtual space may include information such as the background of the virtual object 62 in addition to the virtual object 62 that is the 3D model.

Then, the display control device 100 generates two-dimensional or three-dimensional video content from the extracted information about the virtual space. Then, the display control device 100 transmits the generated video content to the visual display 20. While the pointing device 10 is operated, the display control device 100 may generate a video for each unit time for acquiring information from the pointing device 10 to transmit the generated image to the visual display 20. As a result, the display control device 100 can display the video obtained by capturing the virtual object 62 on the visual display 20 in real time in accordance with the operation by the user 50.

As described above with reference to FIGS. 1 to 4, according to the display control process according to the embodiment, it is possible to virtually capture the stereoscopically displayed virtual content using the input apparatus operable in the real space, and thus, it is possible to simply and intuitively control the display of the virtual content.

Note that each device in FIG. 1 conceptually illustrates a function in the display control system 1, and can take various modes depending on the embodiment. For example, the display control device 100 may include two or more devices different for each function to be described later.

Alternatively, the display control device 100 may be incorporated in a control unit of the stereoscopic display 30. Furthermore, the number of input apparatuses, the number of the visual displays 20, and the number of the stereoscopic displays 30 included in the display control system 1 are not limited to the illustrated number.

### (1-2. Configuration of Display Control Device According to Embodiment)

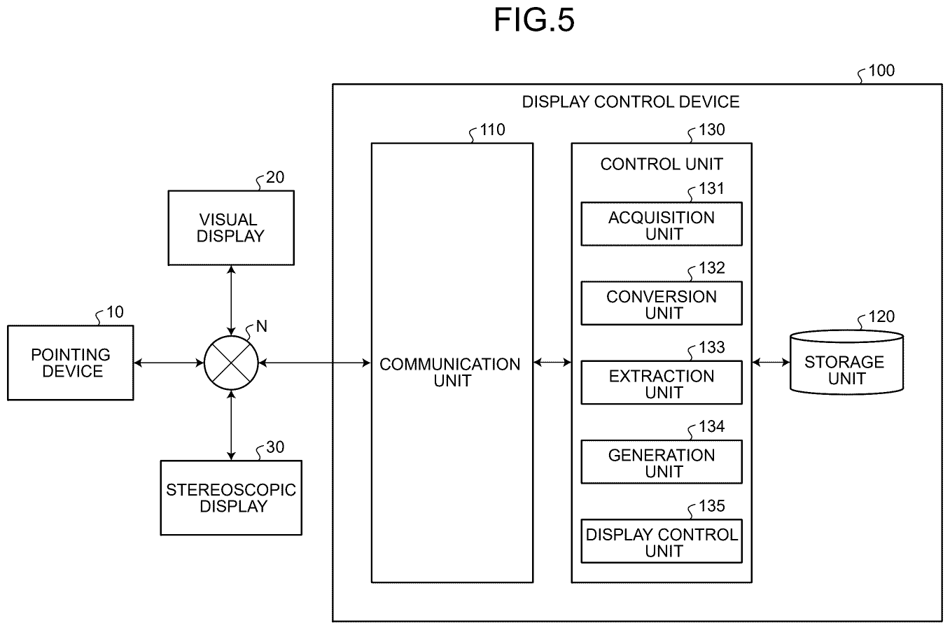

Next, a configuration of the display control device 100 will be described. FIG. 5 is a diagram illustrating a configuration example of the display control device 100 according to the embodiment.

As illustrated in FIG. 5, the display control device 100 includes a communication unit 110, a storage unit 120, and a control unit 130. Note that the display control device 100 may include an input unit (a keyboard, a touch panel, or the like) that receives various operations from an administrator or the like who manages the display control device 100, and a display unit (a liquid crystal display or the like) for displaying various types of information.

The communication unit 110 is realized by, for example, a network interface card (NIC), a network interface controller, or the like. The communication unit 110 is connected to a network N in a wired or wireless manner to transmit and receive information to and from the pointing device 10, the visual display 20, the stereoscopic display 30, and the like via the network N. The network N is realized by, for example, a wireless communication standard or system such as Bluetooth (registered trademark), the Internet, Wi-Fi (registered trademark), an ultra wide band (UWB), or a low power wide area (LPWA).

The storage unit 120 is realized by, for example, a semiconductor memory element such as a random access memory (RAM) and a flash memory, or a storage device such as a hard disk and an optical disk.

The storage unit 120 stores various types of information related to the display control process according to the embodiment. For example, the storage unit 120 stores information about the virtual content to be displayed on the stereoscopic display 30. Furthermore, the storage unit 120 stores camera parameters and the like set in the pointing device 10. In addition, the storage unit 120 stores the video content generated by the control unit 130.

The control unit 130 is realized by, for example, a central processing unit (CPU), a micro processing unit (MPU), a GPU, or the like executing a program (for example, a display control program according to the present disclosure) stored inside the display control device 100 using a random access memory (RAM) or the like as a work area. The control unit 130 may be a controller, and may be realized by an integrated circuit such as an application specific integrated circuit (ASIC) or a field programmable gate array (FPGA).

As illustrated in FIG. 5, the control unit 130 includes an acquisition unit 131, a conversion unit 132, an extraction unit 133, a generation unit 134, and a display control unit 135.

The acquisition unit 131 acquires various types of information. For example, the acquisition unit 131 acquires an input value from an input apparatus located in the real space. Specifically, the acquisition unit 131 acquires the position and posture information about the pointing device 10 detected by an input apparatus having a sensor such as the pointing device 10.

Note that, as described above, it is not always necessary for the input apparatus itself to acquire the position and posture information. For example, the acquisition unit 131 may acquire the position and posture information about the input apparatus detected by the sensor unit 32 included in the stereoscopic display 30.

Alternatively, the acquisition unit 131 may acquire the position and posture information about the input apparatus detected by an external device different from any of the input apparatus, the stereoscopic display 30, and the display control device 100. For example, the acquisition unit 131 may acquire the position and posture information about the input apparatus acquired by a fixed camera, or the like, capable of capturing the entire range in which the stereoscopic display 30 and the input apparatus are installed. In this case, the acquisition unit 131 executes calibration for matching the coordinate space of the fixed camera with the coordinate spaces of the stereoscopic display 30 and the input apparatus in advance using a known technique such as a VR technique. Then, the fixed camera acquires the position and posture information about the input apparatus by recognizing a marker or the like attached to the object. According to such a configuration, the acquisition unit 131 can handle any object such as a marker attached to the user's finger, face, or the like as the input apparatus regardless of the mode of the input apparatus. Furthermore, for example, in a case where a smartphone is used as the input apparatus, the display control device 100 may transmit a predetermined marker image to the smartphone and display the marker on the screen of the smartphone. Furthermore, the display control device 100 may project the marker image onto an any object and cause the fixed camera to read the projected marker.

Based on the input value acquired by the acquisition unit 131, the conversion unit 132 matches the coordinate system of the stereoscopic display 30 with the coordinate system of the pointing device 10 in the real space. For example, the conversion unit 132 converts the coordinate system so that the position of the pointing device 10 in the real space is superimpose on the position of the virtual camera moving in the virtual space.

The conversion unit 132 may perform conversion using any known technique. For example, the conversion unit 132 calculates a conversion matrix for matching the coordinate system of the stereoscopic display 30 with the coordinate system of the pointing device 10 in the real space by comparing the known coordinates in the calibration in advance.

As an example of the calibration, a method can be used in which the conversion unit 132 displays any four points in the virtual space on the stereoscopic display 30, and the user 50 indicates the positions by an any operation such as touching or clicking using the pointing device 10. Consequently, the conversion unit 132 can acquire the relative positional relationship in the pointing device 10 as the known coordinate set. The conversion unit 132 calculates a conversion matrix that aligns these coordinate axes. Note that, as described above, in a case where the fixed camera or the like is installed in the real space, the conversion unit 132 may obtain the position and posture information about the pointing device 10 in the real space from the captured image data of the fixed camera or the like, and perform calibration using the obtained data.

The extraction unit 133 extracts part of the virtual content in the virtual space based on the position and posture information about the input apparatus from the virtual content stereoscopically displayed in the real space by the stereoscopic display 30.

Prior to the extraction processing, the extraction unit 133 determines whether setting related to imaging is performed by the user 50. In a case where there is a setting by the user 50, the extraction unit 133 reflects the setting in the virtual camera. Note that the user setting may include not only camera parameters such as the focal length but also information about rendering such as whether the video content to be output is two-dimensional or three-dimensional.

Furthermore, although details will be described later, the user setting may include a setting regarding a technique at the time of imaging, such as information about a target point such as which object the camera tracks. In a case where a plurality of target points is set, the extraction unit 133 may update the setting at the time of imaging, such as performing pre-setting so that the extraction range centered on the target is corrected to be smoothly switched when the plurality of targets is changed at the time of imaging. Note that the setting of the target may be not only performed by the designation of the user 50 but also automatically performed by using automatic object recognition or automatic space recognition by machine learning or the like. Furthermore, in a case where the three-dimensional video content is finally generated by applying the target setting, the extraction unit 133 may perform setting to automatically correct the content so that the camerawork to support the creation of the video that hardly induces carsickness of the user 50 is obtained.

After reflecting the setting by the user 50, the extraction unit 133 extracts part of the virtual content from the virtual content stereoscopically displayed by the stereoscopic display 30 at the first angle of view corresponding to the line-of-sight of the user 50 based on the position and posture information about the input apparatus. That is, the extraction unit 133 extracts the virtual space displayed by the stereoscopic display 30 based on the information indicating the pointing direction of the pointing device 10 in the real space.

More specifically, the extraction unit 133 extracts part of the virtual content with the second angle of view based on the position and posture information about the input apparatus. The second angle of view in this case is determined based on, for example, a distance from a virtual object to be imaged in the virtual space after the position and posture information about the input apparatus is converted into the virtual space. Alternatively, as described above, the extraction unit 133 may set an angle of view fixed in advance as the second angle of view.

Note that, in a case where there is an explicit setting by the user 50, the extraction unit 133 may apply a camera parameter set in advance by the user 50 to the virtual camera 84 disposed in the virtual space based on the position and posture information about the input apparatus, and extract the range of the virtual space corresponding to the second angle of view that is the angle of view when the virtual space is imaged by the virtual camera 84. For example, the extraction unit 133 extracts the range of the virtual space based on the focal length and the second angle of view set in advance by the user 50.

Furthermore, the extraction unit 133 may extract part of the virtual content by performing correction so that a predetermined object set by the user 50 as an imaging target is included in the second angle of view. That is, the extraction unit 133 may receive the setting of the target point, perform correction so that the target point always falls within the angle of view, and extract the virtual space. As a result, even in a case where the user 50 unintentionally moves the pointing device 10 largely, the extraction unit 133 can extract the virtual space corrected so that the target point does not deviate from the angle of view.

Furthermore, the extraction unit 133 may extract a range of the virtual space corresponding to the second angle of view when the virtual space is imaged by the virtual camera 84 based on the camera trajectory set by the user. As described above, since the input apparatus such as the pointing device 10 is easily moved in the real space, the user 50 may set the imaging trajectory in advance via the input apparatus. Then, when the reproduction of the virtual content is started by the stereoscopic display 30, the extraction unit 133 extracts the virtual space based on the set trajectory. With this configuration, the user 50 can visualize the virtual content as intended by the user 50 without the operating pointing device 10 in real time.

The generation unit 134 generates the video content based on the information extracted by the extraction unit 133. For example, the generation unit 134 generates the video content by rendering the extracted virtual space into a two-dimensional or three-dimensional image based on the setting by the user or the display requirement of the visual display 20.

Note that the generation unit 134 may transmit the generated video content to the display control unit 135 in order to output the generated video content, or may store the generated video content in the storage unit 120 or an external apparatus so that the generated video content can be reproduced in an any format later. Such video content may include not only image information but also setting information such as a trajectory of the virtual camera in the virtual space and camera parameters.

The display control unit 135 causes an external display to display the video content generated by the generation unit 134. That is, the display control unit 135 outputs the virtual space video rendered as the video content to the output destination device. The output destination device may be a device that three-dimensionally outputs a video, such as a head mounted display, a stereoscopic display, or a 3D monitor, or may be a device that two-dimensionally outputs a video, such as the visual display 20 illustrated in FIG. 1 or the like, a smartphone, or a television.

When displaying the three-dimensional video, the display control unit 135 may display the video content configured by the three-dimensional information on the external display based on the viewpoint in the virtual space set based on the position and posture information about the input apparatus. In a case where the external display is a head mounted display, the user wearing the head mounted display can experience a video as if the user has entered the virtual content in accordance with the operation of the input apparatus by the user 50.

### (1-3. Procedure of Processing According to Embodiment)

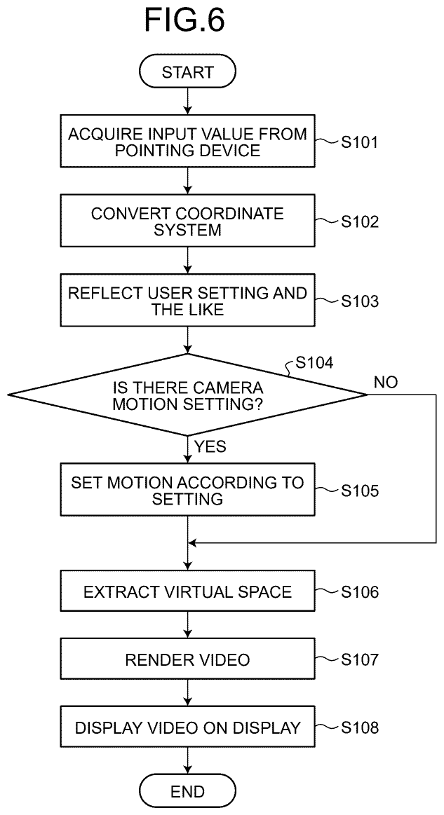

A procedure of processing according to the embodiment will be described with reference to FIG. 6. FIG. 6 is a flowchart illustrating a flow of processing according to the embodiment.

As illustrated in FIG. 6, the display control device 100 acquires an input value such as position and posture information from the pointing device 10 (Step S101). The display control device 100 converts the coordinate system of the input value into the coordinate system of the virtual space using a conversion function or the like calculated in advance (Step S102).

Subsequently, when extracting the virtual space, the display control device 100 reflects user setting or the like such as an output method of the video content (Step S103). At this time, the display control device 100 determines whether there is camera motion setting or the like (Step S104). When the camera motion is set (Step S104; Yes), the display control device 100 gives a motion according to the setting to the virtual camera (Step S105).

When there is no camera motion setting (Step S104; No), the display control device 100 extracts the virtual space in accordance with the motion of the pointing device 10 (Step S106). Note that, in a case where the motion of the camera is set, the display control device 100 extracts the virtual space in accordance with the preset motion of the virtual camera.

Subsequently, the display control device 100 renders a video based on the extracted virtual space (Step S107). Then, the display control device 100 displays the rendered video on the display (Step S108).

### (1-4. Modifications)

### (1-4-1. Detection Process of Imaging Target)

The processing according to the above embodiment may be accompanied by various modifications. For example, in the above embodiment, an example is described in which the user 50 designates a target point to be imaged. The display control device 100 may automatically detect such an imaging target.

That is, the extraction unit 133 according to the display control device 100 may detect a predetermined object included in the virtual content and extract part of the virtual content with the second angle of view corrected so as to include the detected object.

For example, in a case where the predetermined object imitates a person such as a character, the extraction unit 133 may detect the face of the object and correct the second angle of view so as to include the face of the object in the angle of view. As an example, the extraction unit 133 can detect a face of a character using a machine learning model that has learned face detection of a person, and correct the second angle of view so as to track the detected face.

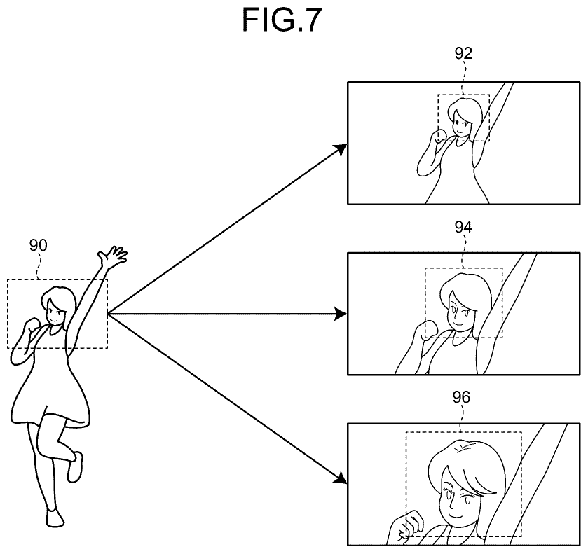

This point will be described with reference to FIG. 7. FIG. 7 is a diagram illustrating an example of a display control process according to a modification.

FIG. 7 illustrates a virtual object and a marker 90 displayed when a face of the virtual object is detected. For example, in a case where the virtual object is included in the second angle of view set in the pointing device 10, the display control device 100 detects the face of the virtual object using the learned face detection model or the like.

The display control device 100 appropriately detects the face of the virtual object according to the angle of view that changes in accordance with the motion of the pointing device 10. For example, in the example illustrated in FIG. 7, as indicated by a marker 92, a marker 94, and a marker 96, the display control device 100 detects the face of the virtual object captured at various angle of views.

Then, the display control device 100 extracts the virtual space based on the detected information. For example, the display control device 100 automatically corrects the motion and blurring of the virtual camera and extracts the virtual space so that the detected face falls within a predetermined range (near the center or the like) of the angle of view. As a result, for example, in a case where the user 50 gradually moves the pointing device 10 away from the virtual object, the display control device 100 can generate the video content in which the face of the virtual object is maintained near the center as indicated by the marker 94 and the marker 96.

Note that the target detected by the display control device 100 is not limited to the face, and the display control device 100 can detect an any target by changing the learning data of the detection model.

### (1-4-2. Modifications Regarding Imaging Direction)

In addition, the display control device 100 may generate the video content by an angle of view other than the direction which the pointing device 10 points.

As an example, the extraction unit 133 according to the display control device 100 may set a gaze point in the virtual content based on the position and posture information about the input apparatus, and may extract part of the virtual content based on a third angle of view connecting a line-of-sight of the user 50 and the gaze point.

For example, the user 50 may wish to view around the position pointed by the pointing device 10 while maintaining the appearance of his or her own viewpoint from which the stereoscopic display 30 is viewed. At this time, the extraction unit 133 may extract the virtual space so that the position pointed by the pointing device 10 is included in the angle of view while maintaining the line-of-sight direction of the user 50 instead of the angle of view corresponding to the direction pointed by the pointing device 10. This means rotation (movement) in the imaging direction, such as extraction of the virtual space at the position pointed by the pointing device 10 and in the direction viewed from the viewpoint position of the user. As described above, the extraction unit 133 can flexibly extract the virtual space from various angles such as the line-of-sight direction of the user instead of extracting only the direction pointed by the pointing device 10. Note that, when extracting the virtual space as the three-dimensional space, the extraction unit 133 may extract the virtual space in an any shape indicated by a guide (arbitrary viewpoint information) in the virtual space.

(1-4-3. Display Control Process with a Plurality of Input Apparatuses)

Further, the display control device 100 may generate the video content using the plurality of the pointing devices 10.

For example, the display control device 100 acquires the position and posture information about the plurality of input apparatuses, and extracts part of the virtual content based on the position and posture information about each of the plurality of input apparatuses. Further, the display control device 100 generates a plurality of pieces of video content based on the extracted information, and displays the plurality of pieces of video content so that user 50 is allowed to arbitrarily switch the plurality of pieces of video content.

As a result, the display control device 100 can easily create the multi-viewpoint video as if one virtual object is imaged from various angles. In this case, the display control device 100 may set one virtual object to be imaged as a target point, and perform correction processing of appropriately placing the target point within the angle of view in any video.

### 2. Other Embodiments

The processing according to each embodiment described above may be performed in various different forms other than the embodiments described above.

Further, it is also possible to manually perform all or part of the processing described as being performed automatically in the processing described in the above embodiment, or alternatively, it is also possible to automatically perform all or part of the processing described as being performed manually by a known method. In addition, the processing procedure, specific name, and information including various pieces of data and parameters illustrated in the above document and drawings can be arbitrarily changed unless otherwise specified. For example, the various types of information illustrated in each figure are not limited to the illustrated information.

Further, each component of each of the illustrated devices is a functional concept, and does not necessarily have to be physically configured as illustrated in the figure. That is, the specific form of distribution/integration of each device is not limited to the one illustrated in the figure, and all or part of the device can be functionally or physically distributed/integrated in any unit according to various loads and usage statuses. For example, the conversion unit 132 and the extraction unit 133 may be integrated.

Further, the above-described embodiments and modifications can be appropriately combined in a range where the processing details do not contradict each other.

Further, the effects described in the present specification are merely examples and are not limiting, and other effects may be present.

### 3. Effects of Display Control Device According to Present Disclosure

As described above, the display control device (the display control device 100 in the embodiment) according to the present disclosure includes the acquisition unit (the acquisition unit 131 in the embodiment), the extraction unit (the extraction unit 133 in the embodiment), and the generation unit (the generation unit 134 in the embodiment). The acquisition unit acquires position and posture information about the input apparatus (the pointing device 10 in the embodiment) located in the real space. The extraction unit extracts part of the virtual content in the virtual space based on the position and posture information about the input apparatus from the virtual content stereoscopically displayed in the real space by the stereoscopic display (the stereoscopic display 30 in the embodiment). The generation unit generates the video content based on the information extracted by the extraction unit.

As described above, the display control device according to the present disclosure uses the stereoscopic display capable of viewing the virtual space from the real space at the third-person viewpoint and the input apparatus operable in the real space, thereby enabling the user to extract a desired range of the virtual space while holding an objective viewpoint. That is, according to the display control device, the user can simply and intuitively control the display of the virtual content.

Further, the extraction unit extracts part of the virtual content with the second angle of view based on the position and posture information about the input apparatus. The generation unit generates the video content corresponding to the second angle of view.

As described above, the display control device can handle the input apparatus as if the input apparatus is a camera in the real world and identify the extraction range of the virtual space by giving an any angle of view to the input apparatus. In other words, the user can cut out a desired range of the virtual space just by moving the input apparatus, like imaging by a real camera.

Furthermore, the extraction unit detects a predetermined object included in the virtual content, and extracts part of the virtual content with the second angle of view corrected so as to include the detected object.

As described above, by targeting the detected object, the display control device can appropriately place the object or the like desired to be imaged by the user within the extraction range.

Further, the extraction unit detects a face of a predetermined object, and corrects the second angle of view so as to include the face of the predetermined object in the angle of view.

As described above, the display control device can realize the extraction processing of automatically tracking the object by applying a technology such as face detection.

Furthermore, the extraction unit sets a gaze point in the virtual content based on the position and posture information about the input apparatus, and extracts part of the virtual content based on the third angle of view connecting the user's line-of-sight and the gaze point. The generation unit generates the video content corresponding to the third angle of view.

As described above, since the display control device can also extract the virtual space at the position designated by the input apparatus and at the angle of view based on the viewpoint of the user, it is possible to generate various pieces of video content corresponding to various user requests.

Furthermore, the extraction unit applies a camera parameter set in advance by the user to the virtual camera (the virtual camera 84 in the embodiment) disposed in the virtual space based on the position and posture information about the input apparatus, and extracts a range of the virtual space corresponding to the second angle of view that is the angle of view when the virtual camera captures an image of the virtual space.

As described above, the display control device can provide the user with an experience that is not different from imaging in the real world by extracting the virtual space with the camera parameters based on the setting by the user.

Furthermore, the extraction unit performs correction so that the predetermined object set as the imaging target by the user is included in the second angle of view, and extracts part of the virtual content.

As described above, the display control device can easily generate the video content as intended by the user by extracting the virtual space so as to track the target point set by the user.

In addition, the extraction unit extracts a range of the virtual space corresponding to the second angle of view when the virtual space is imaged by the virtual camera based on the camera trajectory set by the user.

As described above, since the display control device can also extract the virtual space on the preset trajectory, the video content desired by the user can be generated without the user moving the input apparatus in real time.

In addition, the acquisition unit acquires position and posture information about the input apparatus detected by a sensor included in the input apparatus.

As described above, the display control device can accurately grasp the position and posture of the input apparatus by acquiring the position and posture information with the sensor included in the input apparatus itself.

In addition, the acquisition unit acquires position and posture information about the input apparatus detected by a sensor included in the stereoscopic display.

As described above, the display control device may use information detected by the stereoscopic display as the position and posture information about the input apparatus. As a result, the display control device can easily grasp the relative positional relationship between the stereoscopic display and the input apparatus.

In addition, the acquisition unit acquires position and posture information about the input apparatus detected by an external device different from any of the input apparatus, the stereoscopic display, and the display control device.

As described above, the display control device may acquire the position and posture information about the input apparatus using the external device. As a result, the display control device can handle any object such as a marker attached to the user's finger, face, or the like as the input apparatus regardless of the configuration of the input apparatus, so that a more flexible system configuration can be realized.

Furthermore, the display control device further includes a display control unit (display control unit 135 in the embodiment) that controls to display the video content generated by the generation unit on an external display (visual display 20 in the embodiment).

In this manner, the display control device displays the information obtained by cutting off the virtual space in a form of a video. As a result, the user can easily visualize the virtual content while confirming the texture and appearance of the virtual content.

The generation unit also generates video content including three-dimensional information. The display control unit displays the video content including the three-dimensional information on the external display based on the viewpoint in the virtual space set based on the position and posture information about the input apparatus.

As described above, the display control device can provide not only a two-dimensional video but also a three-dimensional image excellent in a sense of immersion by giving an any viewpoint to the extracted information.

The acquisition unit acquires position and posture information about the plurality of input apparatuses. The extraction unit extracts part of the virtual content based on the position and posture information about each of the plurality of input apparatuses. The generation unit generates a plurality of pieces of video content based on the information extracted by the extraction unit. The display control unit displays the plurality of pieces of video content so that the user is allowed to arbitrarily switch the plurality of pieces of video content.

As described above, since the display control device can generate a plurality of videos using a plurality of input apparatuses, it is possible to easily create a so-called multi-viewpoint video in which one virtual content is viewed from various angles.

### 4. Hardware Configuration

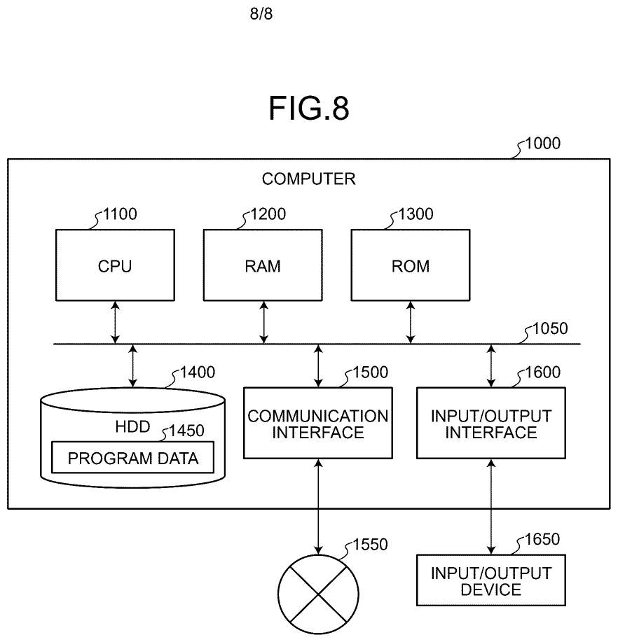

The information device such as the display control device 100 and the pointing device 10 according to each embodiment described above is realized by a computer 1000 having a configuration as illustrated in FIG. 8, for example. Hereinafter, the display control device 100 will be described as an example. FIG. 8 is a hardware configuration diagram illustrating an example of the computer 1000 that implements the functions of the display control device 100. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and performs a process corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records a display control program according to the present disclosure as an example of the program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface that connects an input/output device 1650 and the computer 1000. For example, the CPU 1100 receives data from an input device such as a keyboard and a mouse via the input/output interface 1600. In addition, the CPU 1100 transmits data to an output device such as a display, an edge, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the display control device 100 according to the embodiment, the CPU 1100 of the computer 1000 realizes the functions of the control unit 130 and the like by executing the display control program loaded on the RAM 1200. In addition, the HDD 1400 stores a display control program according to the present disclosure and data in the storage unit 120. The CPU 1100 reads the program data 1450 from the HDD 1400 and executes the program data, but as another example, the program may be acquired from another device via the external network 1550.

The present technology may also be configured as below.
(1) A display control device comprising:
   an acquisition unit that acquires position and posture information about an input apparatus located in a real space;
   an extraction unit that extracts, from virtual content stereoscopically displayed in the real space by a stereoscopic display, part of the virtual content in a virtual space based on the position and posture information about the input apparatus; and
   a generation unit that generates video content based on information extracted by the extraction unit.
(2) The display control device according to (1), wherein the extraction unit
   extracts part of the virtual content from the virtual content stereoscopically displayed by the stereoscopic display at a first angle of view corresponding to a line-of-sight of a user based on position and posture information about the input apparatus.
(3) The display control device according to (2), wherein
   the extraction unit
   extracts part of the virtual content with a second angle of view based on the position and posture information about the input apparatus, and
   the generation unit
   generates the video content corresponding to the second angle of view.
(4) The display control device according to (3), wherein
   the extraction unit
   detects a predetermined object included in the virtual content, and extracts part of the virtual content with the second angle of view corrected so as to include the detected object.
(5) The display control device according to (4), wherein
   the extraction unit
   detects a face of the predetermined object and corrects the second angle of view so as to include the face of the predetermined object in the angle of view.
(6) The display control device according to any one of (2) to (5), wherein
   the extraction unit
   sets a gaze point in the virtual content based on position and posture information about the input apparatus, and extracts part of the virtual content based on a third angle of view connecting a line-of-sight of the user and the gaze point, and
   the generation unit
   generates the video content corresponding to the third angle of view.
(7) The display control device according to any one of (2) to (6), wherein
   the extraction unit
   applies a camera parameter set in advance by the user to a virtual camera disposed in a virtual space based on position and posture information about the input apparatus, and extracts a range of a virtual space corresponding to a second angle of view that is an angle of view when the virtual space is imaged by the virtual camera.
(8) The display control device according to (7), wherein
   the extraction unit
   extracts part of the virtual content by performing correction so that a predetermined object set, by the user, as an imaging target is included in the second angle of view.
(9) The display control device according to (7) or (8), wherein
   the extraction unit
   extracts a range of a virtual space corresponding to the second angle of view when the virtual space is imaged by the virtual camera based on a camera trajectory set by the user.
(10) The display control device according to any one of (1) to (9), wherein
   the acquisition unit
   acquires position and posture information about the input apparatus detected by a sensor included in the input apparatus.
(11) The display control device according to any one of (1) to (10), wherein
   the acquisition unit
   acquires position and posture information about the input apparatus detected by a sensor included in the stereoscopic display.
(12) The display control device according to any one of (1) to (11), wherein
   the acquisition unit
   acquires position and posture information about the input apparatus detected by an external device different from any of the input apparatus, the stereoscopic display, and the display control device.
(13) The display control device according to any one of (1) to (12), further comprising:
   a display control unit that performs control so as to display the video content generated by the generation unit on an external display.
(14) The display control device according to (13), wherein
   the generation unit
   generates the video content including three-dimensional information, and
   the display control unit
   displays video content including the three-dimensional information on the external display based on a viewpoint in a virtual space set based on position and posture information about the input apparatus.
(15) The display control device according to (13) or (14), wherein
   the acquisition unit
   acquires position and posture information about a plurality of the input apparatuses,
   the extraction unit
   extracts part of the virtual content based on position and posture information about each of the plurality of input apparatuses,
   the generation unit
   generates a plurality of pieces of the video content based on information extracted by the extraction unit, and
   the display control unit
   displays the plurality of pieces of the video content so that the user is allowed to arbitrarily switch the plurality of pieces of the video content.
(16) A display control method executed by a computer, the method comprising:
   acquiring position and posture information about an input apparatus located in a real space;
   extracting, from virtual content stereoscopically displayed in the real space by a stereoscopic display, part of the virtual content in a virtual space based on the position and posture information about the input apparatus; and
   generating video content based on the extracted information.
(17) A display control program causing a computer to function as:
an acquisition unit that acquires position and posture information about an input apparatus located in a real space;
an extraction unit that extracts, from virtual content stereoscopically displayed in the real space by a stereoscopic display, part of the virtual content in a virtual space based on the position and posture information about the input apparatus; and
a generation unit that generates video content based on information extracted by the extraction unit.

### REFERENCE SIGNS LIST

1 DISPLAY CONTROL SYSTEM
10 POINTING DEVICE
20 VISUAL DISPLAY
30 STEREOSCOPIC DISPLAY
50 USER
100 DISPLAY CONTROL DEVICE
110 COMMUNICATION UNIT
120 STORAGE UNIT
130 CONTROL UNIT
131 ACQUISITION UNIT
132 CONVERSION UNIT
133 EXTRACTION UNIT
134 GENERATION UNIT
135 DISPLAY CONTROL UNIT

1. A display control device comprising:
an acquisition unit that acquires position and posture information about an input apparatus located in a real space;
an extraction unit that extracts, from virtual content stereoscopically displayed in the real space by a stereoscopic display, part of the virtual content in a virtual space based on the position and posture information about the input apparatus; and
a generation unit that generates video content based on information extracted by the extraction unit.

2. The display control device according to claim 1, wherein
the extraction unit
extracts part of the virtual content from the virtual content stereoscopically displayed by the stereoscopic display at a first angle of view corresponding to a line-of-sight of a user based on position and posture information about the input apparatus.

3. The display control device according to claim 2,
wherein
the extraction unit extracts part of the virtual content with a second angle of view based on the position and posture information about the input apparatus, and
the generation unit
generates the video content corresponding to the second angle of view.

4. The display control device according to claim 3, wherein
the extraction unit
detects a predetermined object included in the virtual content, and extracts part of the virtual content with the second angle of view corrected so as to include the detected object.

5. The display control device according to claim 4, wherein
the extraction unit
detects a face of the predetermined object and corrects the second angle of view so as to include the face of the predetermined object in the angle of view.

6. The display control device according to claim 2, wherein
the extraction unit
sets a gaze point in the virtual content based on position and posture information about the input apparatus, and extracts part of the virtual content based on a third angle of view connecting a line-of-sight of the user and the gaze point, and
the generation unit
generates the video content corresponding to the third angle of view.

7. The display control device according to claim 2, wherein
the extraction unit
applies a camera parameter set in advance by the user to a virtual camera disposed in a virtual space based on position and posture information about the input apparatus, and extracts a range of a virtual space corresponding to a second angle of view that is an angle of view when the virtual space is imaged by the virtual camera.

8. The display control device according to claim 7, wherein
the extraction unit
extracts part of the virtual content by performing correction so that a predetermined object set, by the user, as an imaging target is included in the second angle of view.

9. The display control device according to claim 7, wherein
the extraction unit
extracts a range of a virtual space corresponding to the second angle of view when the virtual space is imaged by the virtual camera based on a camera trajectory set by the user.

10. The display control device according to claim 1, wherein
the acquisition unit
acquires position and posture information about the input apparatus detected by a sensor included in the input apparatus.

11. The display control device according to claim 1, wherein
the acquisition unit
acquires position and posture information about the input apparatus detected by a sensor included in the stereoscopic display.

12. The display control device according to claim 1, wherein
the acquisition unit
acquires position and posture information about the input apparatus detected by an external device different from any of the input apparatus, the stereoscopic display, and the display control device.

13. The display control device according to claim 2, further comprising:
a display control unit that performs control so as to display the video content generated by the generation unit on an external display.

14. The display control device according to claim 13, wherein
the generation unit
generates the video content including three-dimensional information, and
the display control unit
displays video content including the three-dimensional information on the external display based on a viewpoint in a virtual space set based on position and posture information about the input apparatus.

15. The display control device according to claim 13, wherein
the acquisition unit
acquires position and posture information about a plurality of the input apparatuses,
the extraction unit
extracts part of the virtual content based on position and posture information about each of the plurality of input apparatuses,
the generation unit
generates a plurality of pieces of the video content based on information extracted by the extraction unit, and
the display control unit
displays the plurality of pieces of the video content so that the user is allowed to arbitrarily switch the plurality of pieces of the video content.

16. A display control method executed by a computer, the method comprising:
acquiring position and posture information about an input apparatus located in a real space;
extracting, from virtual content stereoscopically displayed in the real space by a stereoscopic display, part of the virtual content in a virtual space based on the position and posture information about the input apparatus; and
generating video content based on the extracted information.

17. A display control program causing a computer to function as:
an acquisition unit that acquires position and posture information about an input apparatus located in a real space;
an extraction unit that extracts, from virtual content stereoscopically displayed in the real space by a stereoscopic display, part of the virtual content in a virtual space based on the position and posture information about the input apparatus; and
a generation unit that generates video content based on information extracted by the extraction unit.
